(19) United States
(12) Patent Application Publication
(10) Pub. No.: US 2008/0149658 A1
(43) Pub. Date: Jun. 26, 2008

(54) Wireless, remote or mobile shelf pricing with elongate electronic displays and simplified price changes

(75) Inventors: Scott Hudis, Stillwater, MN (US); Paul Ihn, Hudson, WI (US)

Correspondence Address: DOCKET CLERK, P.O. DRAWER 800889, DALLAS, TX, 75380, US

(73) Assignee: CRANE Co., Stamford, CT (US)

(21) Appl. No.: 11/977,443

(22) Filed: Oct. 24, 2007

Related U.S. Application Data
(60) Provisional application No. 60/853,910, filed on Oct. 24, 2006.

(51) Int. Cl. G07F 11/00

(52) U.S. Cl. 221/2; 221/1

(57) ABSTRACT

To avoid the time and cost of manually changing price labels for each product column on each shelf 104, 114 within a vending machine 101, 111, a single elongate price display 206 is provided having an electronic price display region 205 for each product column on the shelf and a single set of electrical connections to the controller 301. Price values for each product column are stored in a memory 302 accessible to the controller and may be quickly and easily changed using an external device, such as a hand held data carrier with a DEXUCS interface or a wireless device. Small price changes may thus be economically effected.

### CROSS-REFERENCE TO RELATED APPLICATIONS

The present application claims the benefit under 35 U.S.C. § 119(e) to U.S. Provisional Patent Application Ser. No. 60/853,910 filed on Oct. 24, 2006.

### TECHNICAL FIELD

The present disclosure is directed, in general, to vending machines and, more specifically, to pricing of products distributed through vending machines.

### BACKGROUND

Many vending machines include a cabinet with a transparent front, with product shelves disposed within the cabinet holding the vend products within multiple selectable queues or columns across each shelf, such that the vend products within each selectable queue or column are visible to the customer. For example, some vending machines hold snacks such as bags of chips, candy bars and the like between consecutive revolutions of helical coils, where drive motors rotate the coils to force a product off the front of the shelf to fall within a space between the shelves and the transparent front into a delivery bin from the vended product may be retrieved by the customer. Other vending machines hold packaged beverages (bottles, cans, etc.) in front-to-back lines or files, with an X-Y picker moving within the space between the shelves and the transparent front to retrieve a selected beverage container and carry the container to a delivery port from which the container may be retrieved by the customer.

With such transparent front vending machines, each queue or column usually has a printed indicia (e.g., label or sticker) of a unique identifier (e.g., A1, A2, A3, . . . , B1, B2, B3, . . . , C1, C2, C3, . . . , etc.) affixed nearby on the shelf's front face, visible through the transparent front and enabling the customer to select a particular vend product, usually by entering the unique identifier associated with a desired vend product on a keypad on the vending machine's exterior. Normally, the printed indicia affixed to the shelf's front face for each queue or column includes an indication of the price for the corresponding vend product.

Both types of vending machines described above very often provide 40 or more selections of different vend products for selection by the customer. As a result, minor price changes (e.g., increases of just $0.05 or ε0.05 per item) generally requires changing a price label or sticker for each item within the machine, as well as modifying the machine controller to deduct the new price from money inserted by the customer.

Furthermore, most vending machine operators operate a significant number of machines dispersed across a wide area, necessitating the changes described above at each machine. Large operators may currently spend a large amount of time going out to their machines to update prices for any price change. The level of required effort may inhibit small and/or incremental price increases on the order of $0.05 or $0.10 and thus preclude maximizing profitability of the vending machines. In addition, the level of required effort economically precludes temporary price decreases to spur sales at a given location.

Alternatives to the predominant use of price labels or tabs have been previously proposed. However, even methods of changing prices within a vending machine controller via computer generally require the computer to be connected to the machine, so that the operator or an employee needs to travel to the machine to effect the price change—travel that is also necessary to change price tabs at the vending machines.

There is, therefore, a need in the art for improved price control at vending machines.

### SUMMARY

To address the above-discussed deficiencies of the prior art, it is a primary object of the present disclosure to provide, for use in avoiding the time and cost of manually changing price labels for each product column on each shelf within a vending machine, a single elongate price display having an electronic price display region for each product column on the shelf and a single set of electrical connections to the controller. Price values for each product column are stored in a memory accessible to the controller and may be quickly and easily changed using an external device, such as a hand held data carrier with a DEXUCS interface or a wireless device. Small price changes may thus be economically effected.

The foregoing has outlined rather broadly the features and technical advantages of the present disclosure so that those skilled in the art may better understand the detailed description that follows. Additional features and advantages will be described hereinafter that form the subject of the claims. Those skilled in the art will appreciate that they may readily use the conception and the specific embodiment disclosed as a basis for modifying or designing other structures for carrying out the same purposes. Those skilled in the art will also realize that such equivalent constructions do not depart from the spirit and scope of this disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIGS. 1A and 1B are illustrations of transparent front vending machines within which shelf pricing using elongate electronic price displays to provide simplified price changes according to various embodiments of the present disclosure;

FIG. 2 illustrates shelves with elongate electronic price displays according to various embodiments of the present disclosure;

FIG. 2A is a partial cross-sectional of a shelf with elongate electronic price displays according to various embodiments of the present disclosure; and

FIG. 3 is a high level block diagram of a control system within a vending machine having shelves with elongate electronic price displays according to various embodiments of the present disclosure.

### DETAILED DESCRIPTION

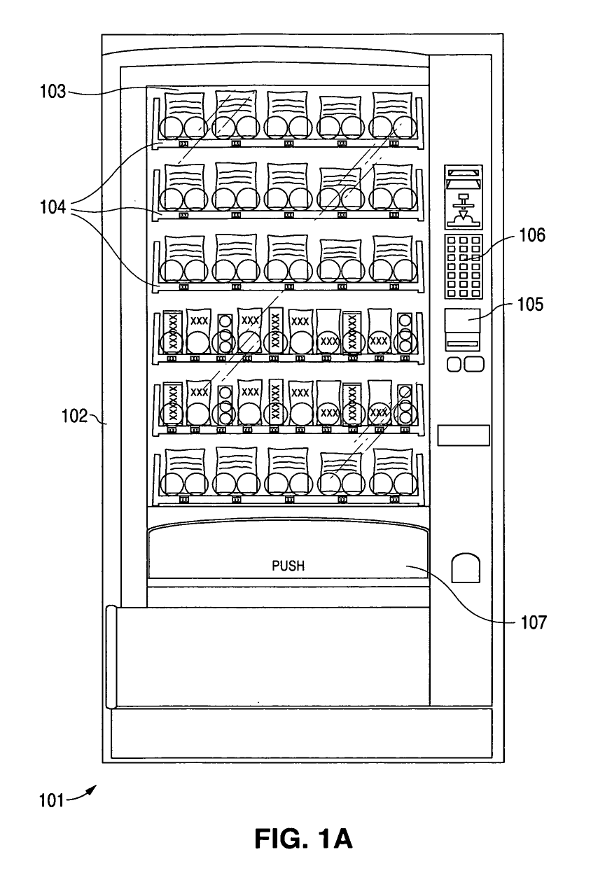

FIGS. 1A through 3, discussed below, and the various embodiments used to describe the principles of the present invention in this patent document are by way of illustration only and should not be construed in any way to limit the scope of the disclosure. Those skilled in the art will understand that the principles of the present invention may be implemented in any suitably arranged device.

FIGS. 1A and 1B are illustrations of transparent front vending machines within which shelf pricing using elongate electronic displays to provide simplified price changes according to various embodiments of the present disclosure. FIG. 1A illustrates a vending machine 101 with a cabinet 102 having a transparent front 103 through which a customer can view the products available for vending. The products are held on shelves 104, between revolutions of helical coils in this exemplary embodiment. Payment for a selected vend product is made through one or more payment acceptors 105 (which may include without limitation any or all of bill and/or coin acceptor(s) and validator(s), a credit/debit cards swipe mechanism, or a wireless communication facility for interacting with a mobile telephone or similar wireless device), and a keypad 106 allows the customer to enter the identifier for a selected vend product. In response to a customer depositing a sufficient amount of money (or otherwise receiving a sufficient credit) and selecting a desired vend product, a controller (not depicted in FIG. 1A) causes a drive motor (also not depicted) to be energized such that the first vend product within the selected coil(s) is forced off the shelf into the space between the shelves and the transparent front, to fall into the delivery bin below the shelves. The customer may then retrieve the vend product from the delivery bin, which is located behind delivery bin door 107.

FIG. 1B also illustrates a vending machine 111 with a cabinet 112 having a transparent front 113 through which a customer can view the products available for vending. The products—packaged beverages in containers such as plastic or glass bottles or aluminum cans in this embodiment—are held on shelves 114, in an upright standing manner within separate queues or files on each shelf. Payment for a selected vend product is made through one or more payment acceptors 115, and a keypad 116 allows the customer to enter the identifier for a selected vend product. The vending machine 111 has a shuttle bar 117 movable within the space between the shelves and the transparent front, with a product carrier 118 mounted on the shuttle bar 117 and movable along the shuttle bar 117. In response to a customer depositing a sufficient amount of money and selecting a desired vend product, a controller (not depicted in FIG. 1B) causes drive motors (also not depicted) to be energized such the shuttle bar 117 and/or product carrier 118 are moved so that product carrier 118 is positioned to receive a vend product from a selected one of the queues or files. The first vend product within the selected queue or file is transferred into the product carrier, which is then moved to deliver the transferred vend product to, and transfer the vend product into, the delivery port 116. The customer may then retrieve the vend product from the delivery port 116.

Shelves 104, 114 may be unitary (e.g., molded plastic) structures or may be segmented as trays that are supported next to each other across the width of the cabinet space for holding vending products. Dividers partition the space for different helical coils holding different vend products or the space for different queues or files of packaged beverages. In the case of the embodiment of FIG. 1A, the snacks may be held between the revolutions of only one helical coil between dividers on a shelf or may be held in between the revolutions of two helical coils operated in tandem. Vend products of different sizes, shapes and/or weights may be disposed in different columns (between adjacent dividers), on different shelves or on the same shelf. In the case of the embodiment of FIG. 1B, the beverage containers may be urged toward the front of each shelf by spring loaded pushers and/or gravity, and an escapement mechanism may prevent the first product within a queue or file from being pushed off the shelf, until released by the product carrier 118. Beverage containers of different sizes, shapes and/or weights, and of different materials (e.g., plastic or glass bottles, or aluminum cans), may be disposed in different queues or files (between adjacent dividers), on different shelves or on the same shelf.

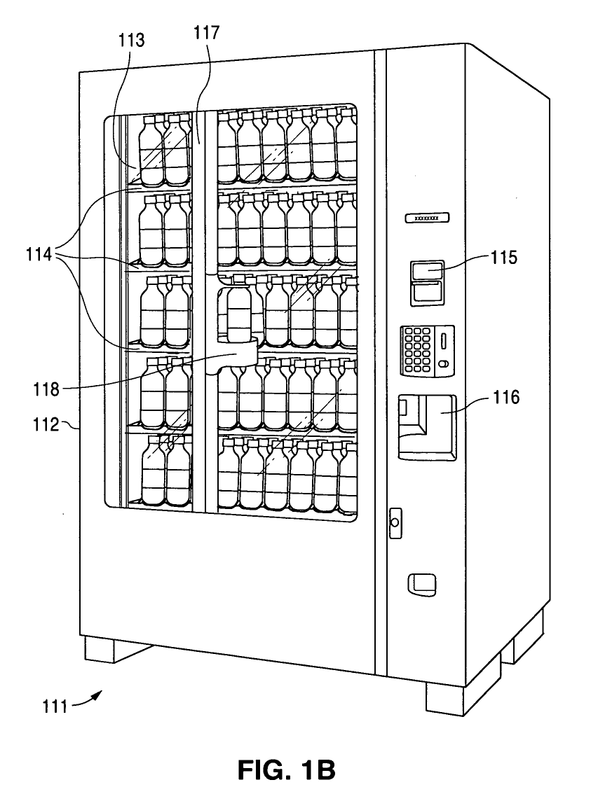

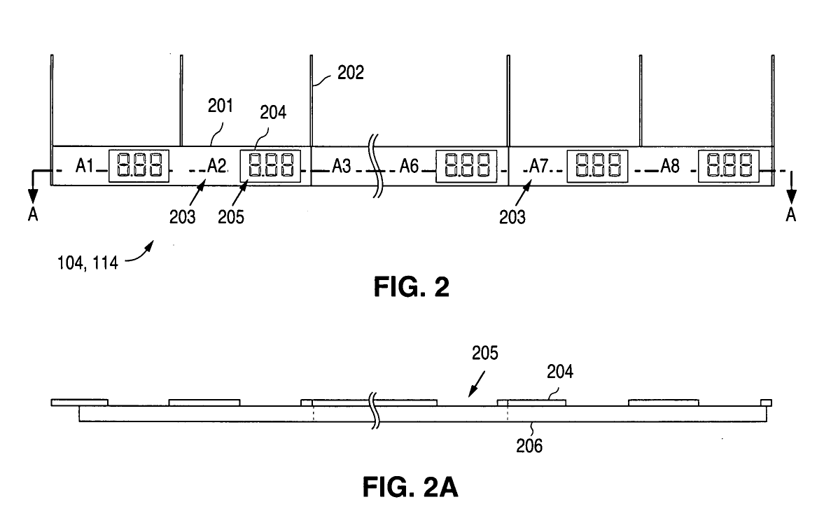

FIG. 2 illustrates shelves with elongate electronic price displays according to various embodiments of the present disclosure. FIG. 2 depicts a front view of a shelf 104, 114 illustrated in FIGS. 1A and 1B, where all shelves within a vending machine all have substantially the same structure. Shelves 104, 114 each include a base 201, implemented as segments mounted adjacent to each other in the example shown, and dividers 202 separating the width of the shelf 104, 114 into a plurality of columns each for holding vend products, either within one or more helical coils between adjacent dividers or as a queue or file of beverage containers. In the example shown, each shelf 104, 114 is divided into eight columns.

A front face of each shelf 104, 114 visible through the transparent front of the vending machine includes an identifier 203 and a cut-out 204 for each column. Of course, the identifier 203 for a particular column may be fixed for the operational lifetime of the vending machine. Accordingly, identifier 203 may take the form of a label, an engraved or embossed plate, etc. affixed to the front face of a shelf 104, 114. The cut-outs 204 for each column are simply openings through the front face of a shelf allowing the structure behind the front face to be visible through the transparent front of the vending machine.

FIG. 2A is a partial cross-sectional of a shelf with elongate electronic price displays according to various embodiments of the present disclosure. The front face of shelf 204 includes cut-outs 205 allowing electronic price display 206 to be visible therethrough. The electronic price display 206 is a single elongate structure extending across substantially an entire width of the respective shelf, at least covering all cut-outs 205 for the respective shelf. The electronic price display 206 has electronic display regions therein aligned with the cut-outs 205. In the exemplary embodiment, the electronic display regions are seven-segment liquid crystal display (LCD) devices suitably mounted and/or encased in a support member, with internal electrical conductors leading to a single connector for the respective shelf.

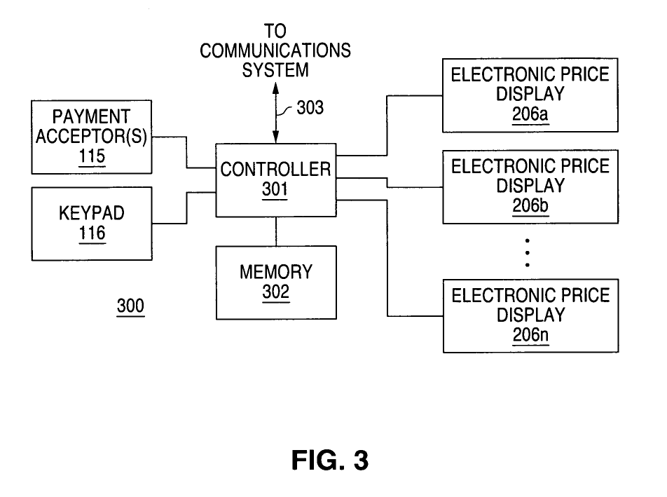

FIG. 3 is a high level block diagram of a control system within a vending machine having shelves with elongate electronic price displays according to various embodiments of the present disclosure. Control system 300 is mounted within the cabinet of the vending machine and includes, in the exemplary embodiment, a controller 300 is bi-directionally coupled to payment acceptors 115 to receive signal indicative of amounts to be credited to a customer. The controller 300 is also coupled to keypad 116 to receive input signals indicative of a customer's vend product selection, and to an electronic price display 206a-206n each associated with one of n shelves within the vending machine. Each electronic price display 206a-206n has the features depicted in FIGS. 2 and 2A and described herein in connection with electronic price display 206, and thus includes multiple addressable electronic display regions, one for each column on the respective shelf.

Controller 301 is also coupled to a memory 302 for storing prices to be displayed by each addressable electronic display region within one of electronic price displays 206a-206n. Memory 302 thus includes a plurality of price values. For example, if a vending machine includes five shelves each having eight columns, the vending machine will include five electronic price displays 206a-206n (one for each shelf) each having eight addressable electronic display regions therein, and memory 302 will contain 40 price values corresponding to each of the forty addressable electronic display regions within the five electronic price displays 206a-206n. During a power-up sequence for controller 301, a control program executing within the controller 301 will configure the electronic price displays 206a-206n to display, within each addressable electronic display region therein, the price value stored within memory 302 for that addressable electronic display region. In addition, controller 301 may include one or more control programs for periodically testing and/or refreshing the values displayed by each addressable electronic display region.

Controller 301 also includes a connection 303 to a communications system (not shown) allowing the price values stored in memory 302 and displayed on the addressable electronic display regions to be changed.

Electronic price display 206 eliminates the need for price tabs or stickers on the front face of the shelves, so that no one actually needs to visit the vending machine in order to physically change the prices on the shelves. Previous attempts to add electronic pricing displays to vending machine shelves had individual displays at each product selection column, each separately wired back to a controller. Such individual displays were too expensive for commercial acceptability. As noted above, however, electronic price displays 206a-206n are strips or elongate members substantially as long as the shelf on which the electronic price display is mounted, with multiple addressable electronic display regions therein and with only one connector for electrical signals back to the controller 301 per shelf. Of course, electronic price display 206 need not be a unitary member, but instead may be segmented as illustrated by the dashed lines within FIG. 2A, with at least one addressable electronic display region within each segment, with physical and electrical connections between adjacent segments, and with all electrical connections coupled through the single connector located, for example, at one end of the electronic price display 206. In fact, the segments need not be physically contiguous when mounted within the vending machine, but may instead be spaced apart and only electrically connected.

By limiting the number of connectors back to the controller 301 to one per shelf (and therefore limiting the number of control pins required for controller 301), such that the cost of implementing electronic price display 206 is about one third the cost of the providing individual displays separately wired back to the controller.

With electronic price displays 206a-106n within the vending machine, there is no need to perform the time-consuming and tedious task of changing price tabs or stickers at each machine, and there is no reason for the operator to go to the vending machine merely to change the price tabs on the shelves. However, there remains a need to get the new price values to the vending machine. At least three alternative mechanisms are available for such purpose:

The current standard in the vending industry for retrieval of accountability information (number of vends, cash in, etc.) from a vending machine is to use a data carrier, a hand held data processing system that plugs into the vending machine via the DEXUCS plug. Current production vending machines have the ability to send accountability information to the data carrier from the vending machine via the DEXUCS interface, but no system currently sends machine setup information from the data carrier back to the vending machine either during the same transaction or in a different transaction using the same communications protocols. In accordance with the present disclosure, for vending machines including the electronic price displays 206a-206n, the data carrier is configured to transmit price values to memory 302 via the DEXUCS interface using communications system connection 303 and controller 301.

In addition, as technology progresses many vending operators are finding it advantageous to use radio and/or mobile communications to communicate with vending machines. The hand held data carriers are being replaced with other, wireless communications systems, such as wireless devices communicating over telephone (voice/broadband) and/or paging (narrow band) radio communications networks, or via Wireless Fidelity (WiFi) local area (data) wireless network connections to handheld devices, to other vending machines or to local “base” stations. As with hand held data carriers, currently only vend accounting information is transmitted from the vending machine, with prices set manually or in some other fashion. In accordance with the present disclosure, machine setup information including price values is alternatively sent wirelessly using the industry standard DEXUCS interface and one or more of such wireless communications devices, again using communications system connection 303 and controller 301.

The third route for updating price values within memory 302 requires a much less expensive infrastructure to transfer information to the vending machine. Using a Universal Serial Bus (USB) memory device (jump drive) plugged into a USB port (not shown) coupled to communications system connection 303 within the control system 300, the controller 301 can load the price values from the USB memory into memory 302 using a program executing in controller, still through the DEXUCS interface.

With the above three routes, price changes are quickly transferred to the vending machine either wirelessly or by a physical connection. This saves the operator considerable time, even if the operator must still travel to the vicinity of the vending machine in order to load the price changes.

Once loaded into the data carrier, USB drive or other data source, the new price information is then assembled for transfer to the vending machine. This front end solution is unique in that presently the front end software operating on a hand held data carrier shows the operator all of the information that has been received from the machine, such as the number of vends during the current operational period, the amount of money received at the vending machine during the current operational period, and the current price by selection. In accordance with the present disclosure, an additional field for “New Price” is added to the data selections that may be viewed and/or modified by the operator. The software is configured so that while the operator is viewing the current price of the selection, the price may be selectively changed merely by entering the new price in the current display (e.g., data carrier display). Once the new price is entered, the data carrier will transmit the new price data to the vending machine at the next interaction with the machine.

The solution described above makes changing prices—as well as other machine settings—a snap, with the added benefit of eliminating possible human errors at the vending machine since the price changes are all handled electronically.

Although the present invention has been described in detail, those skilled in the art will understand that various changes, substitutions, variations, enhancements, nuances, gradations, lesser forms, alterations, revisions, improvements and knock-offs of the invention disclosed herein may be made without departing from the spirit and scope of the invention in its broadest form.

What is claimed is:

1. A system comprising:
a single electronic price display 206 affixed to a shelf 104, 114 within a vending machine 101, 111 and extending across multiple product columns on the shelf, the electronic price display including
a plurality of electronic display regions 205 each positioned in unique correspondence with one of the product columns on the shelf and a single set of electrical connections for all of the electronic display regions to a controller 301 within the vending machine.

2. The system of claim 1, wherein the electronic price display is mounted to the shelf such that each electronic display region is visible through a cut-out 204 in a front face of the shelf.

3. The system of claim 1, wherein the electronic price display includes seven-segment liquid crystal displays.

4. The system of claim 1, further comprising:
a memory 302 within the vending machine containing price values for display by each electronic display region; and
a controller 301 causing the electronic display regions to display the corresponding price value from the memory,
wherein each electronic display region selectively displays a price value separately from other electronic display regions within the electronic price display.

5. The system of claim 4, further comprising:
a communications system connection 303 coupled to the controller and receiving communications signals from a device external to the vending machine, the communications system connection receiving price values from the external device,
wherein the controller causes the received price values to be stored within the memory.

6. The system of claim 5 wherein the external device comprises a hand held data carrier.

7. The system of claim 5 wherein the communications system connection is coupled to a wireless connection.

8. A method of display prices within a vending machine, the method comprising:
employing a single electronic price display affixed to a shelf within a vending machine and extending across multiple product columns on the shelf to display prices,
the electronic price display including a plurality of electronic display regions each positioned in unique correspondence with one of the product columns on the shelf and displaying a price for the products on the shelf,
wherein all electronic display regions within the electronic price display are coupled by a single set of electrical connections to a controller within the vending machine.

9. The method of claim 8, wherein the electronic price display is mounted to the shelf such that each electronic display region is visible through a cut-out in a front face of the shelf.

10. The method of claim 8, wherein the electronic price display includes seven-segment liquid crystal displays.

11. The method of claim 8, further comprising:
storing price values for display by each electronic display region in a memory within the vending machine; and
causing the electronic display regions to display the corresponding price value from the memory,
wherein each electronic display region selectively displays a price value separately from other electronic display regions within the electronic price display.

12. The method of claim 11, further comprising:
receiving communications signals from a device external to the vending machine a communications system connection coupled to the controller, the communications system connection receiving price values from the external device,
wherein the controller causes the received price values to be stored within the memory.

13. The method of claim 12 wherein the external device comprises a hand held data carrier.

14. The method of claim 12 wherein the communications system connection is coupled to a wireless connection.
